(19) United States
(12) Patent Application Publication
(10) Pub. No.: US 2004/0107611 A1
(43) Pub. Date: Jun. 10, 2004

(54) Personalized wine disks and method of manufacture

(76) Inventor: Roma Kohutiak, Niagara Falls, NY (US)

Correspondence Address: Roma Kohuliak, PO Box 382369, Honsberger Avenue, Jordan Station, LOR1SO, CA

(21) Appl. No.: 10/314,571

(22) Filed: Dec. 8, 2002

(51) Int. Cl. G09F 3/00; B32B 3/02; G09F 3/14

(52) U.S. Cl. 40/324; 428/64.1; 40/665

(57) ABSTRACT

The present invention relates to items for decorating and identifying individual pieces of glassware. Previously, band devices and three dimensional charms have been used. However, such items require large quantities to be made. The present invention provide a personalized wine disk and method of manufacture that allows for smaller quantities of personalized wine disks.

### BACKGROUND OF THE INVENTION

This invention relates to disks for hanging around glassware or beverages for the purposes of identifying the owner and for advertising. Charms and identifier rings have become popular to attach to the stem of a wine glass to identify the owner.

U.S. patent application Ser. No. 2001/0054817, applied for by Kelley, discloses that at many gatherings, individual identical pieces of drinkware of different users are indistinguishable from each other. Consequently, they are misidentified and one person mistakenly picks up the drinkware of someone else. As such, band devices, wraps, jewelry, etc. are used to identify the owner of the individual piece of drinkware.

While charms and the like are known within the art, there is a need within the art to provide a disk that may be easily personalized and produced in smaller quantities. Previously, wine charms have been created in large batches. Decorations for drinkware, including wine glasses, typically requires a minimum of one thousand charms in order to achieve economies of scale. It is desirable, though, to provide a device and method of manufacture where smaller amounts are capable of being manufactured economically. This also allows for personalized wine charms.

Previously, charms and jewelry have been used. Attempts to transfer images have been problematic. Because of this, wine charms have been exclusively charms, or three-dimensional renderings. For example, a three dimensional cola bottle may be used to advertise the cola. However, it would be desirable to provide personalized disks. For example, promotional items and advertising where smaller batches are desired have yet to be achieved. Accordingly, what is needed is a way to easily, with little set up, transfer images such that personalized images on disks for wine charms may be provided.

Also, the disks need to be sturdy, resistant to damage, and of a substantial quality. Providing a sturdy disk that is capable of displaying personalized images has heretofore not been possible. Specifically, conventional heat-melt thermal printing uses, primarily, non-active wax materials such as hydrocarbon wax, carnauba wax, ester wax, heat-melt materials and paraffin wax, etc. have been used for printing. Though these wax or wax-like materials serve the purpose of heat melt very well, they present problems when the product is used in a further transfer process, especially when the image is transferred. The conventional wax materials are not chemically bonded or otherwise permanently bonded to the substrate, but are temporarily and loosely bound to the final substrate by the melting of wax during the transfer process. The resulting image is not durable, with the wax materials running and other associated problems including color fastness, poor thermal stability, and rapid and severe image quality deterioration during usage of a product.

In contrast, heat activated, or sublimation, transfer dye solids change to a gas at about 400° F. Once the gasification bonding takes place, the ink is permanently printed and highly resistant to change or fading. While sublimation dyes yield excellent results when a polyester or polymeric substrate is used, these dyes have a limited affinity for other materials, such as wood or metal, unless coated with a polymeric material.

To improve the quality of images transferred onto substrates other than polyester or polymeric substrates, the substrates are coated with materials, such as the coatings described in DeVries et al, U.S. Pat. No. 4,021,591. Application of polymer surface coating materials to bond the ink layer to the substrate allows the surface coating material to bond to the substrate, reducing the absorbency of the ink by the cotton in the transferring material and improving the image quality. Also, the application of images to metal substrates is fraught with problems of stability and retaining integrity. The present invention provides a method wherein photos may be transferred to a personalized wine disk with the quality of the photograph retained.

Accordingly, there is a need within the prior art to provide personalized wine disks and a method of manufacture that allows for the creation of individualized, smaller batch wine disks that are sturdy and of substantial quality.

### SUMMARY OF THE INVENTION

It is envisioned that the present invention may be a device for identifying drinkware having a structural portion, the device comprising: a first ring type member to be attached to a structural portion of drinkware; and an image disk with a hole for the receipt of a second ring type member, wherein the second ring type member passes through the first ring type member so as to allow the image disk to lay flat. The term drinkware may be used to describe coffee cups, tea cups, wine glasses, and any other drinkware known within the art.

According to another aspect of the present invention, a device for identifying drinkware having a structural portion, the device comprising: a first ring type member to be attached to a structural portion of drinkware; and an image disk with a hole for the receipt of the first ring type member so as to allow the image disk to be attached to the structural portion of the drinkware.

According to a further aspect of the present invention, a method of manufacturing an image disk for identifying and advertising on drinkware, comprising the steps of: providing a sheet with a top portion and a bottom portion; coating the sheet with a two-layer plastic comprised of a first plastic layer and a second plastic layer and providing a coated sheet; cutting the coated sheet to provide at least one desired size disk; capturing an image; inputting the image into computer storage; matching the size of the image to the desired size disk; reversing the image to provide a reversed image; printing the reversed image onto transfer paper to provide ink solids on the transfer paper; placing the transfer paper over at least one desired size disk; and pressing the transfer paper and at least one desired size disk at a temperature between 300 and 500 degrees Fahrenheit for a period sufficient to heat activate ink solids to provide an image disk, wherein the image is between the first plastic layer and the second plastic layer; and attaching the image disk to drinkware.

According to another embodiment, a method of manufacturing an image disk for identifying and advertising on drinkware, comprising the steps of: providing a sheet with a top portion and a bottom portion; coating the sheet with a two layer plastic to provide a coated sheet, wherein the two layer plastic is comprised of a first plastic layer with a top portion and a bottom portion and a second plastic layer with a top portion and a bottom portion, the bottom portion of the first plastic layer being in communication with the top portion of the sheet, and the bottom portion of the second plastic layer being in communication with the top portion of the first plastic layer; cutting the coated sheet to provide at least one desired size disk; capturing an image; inputting the image into computer storage; matching the size of the image to the desired size disk; reversing the image to provide a reversed image; printing the reversed image onto transfer paper using heat-activated dyes to provide ink solids on transfer paper; placing the transfer paper over at least one desired size disk; and pressing the transfer paper and the at least one desired size disk at a temperature between 300 and 500 degrees Fahrenheit for a period between 30 seconds and five minutes to heat activate the ink solids to provide an image disk, wherein the image is sublimated under the top portion of the second plastic layer; and attaching the image disk to the drinkware.

According to another embodiment, a method of manufacturing an image disk for identifying and advertising on drinkware, comprising the steps of: providing a sheet with a top portion and a bottom portion; coating the sheet with a two layer plastic to provide a coated sheet, wherein the two layer plastic is comprised of a first plastic layer with a top portion and a bottom portion and a second plastic layer with a top portion and a bottom portion, the bottom portion of the first plastic layer being in communication with the top portion of the sheet, and the bottom portion of the second plastic layer being in communication with the top portion of the first plastic layer; cutting the coated sheet to provide at least one desired size disk; capturing an image; inputting the image into computer storage; matching the size of the image to the desired size disk; reversing the image to provide a reversed image; printing the reversed image onto transfer paper using heat-activated dyes containing a colorant and at least one compound having at least one functional group containing active hydrogen to provide ink solids on the transfer paper; placing the transfer paper over at least one desired size disk; and pressing the transfer paper and at least one desired size disk at a temperature between 300 and 500 degrees Fahrenheit for a period between 30 seconds and five minutes to heat activate ink solids to provide an image disk, wherein the image is sublimated under the top portion of the second plastic layer; and attaching the image disk to the drinkware.

These and other features, aspects, and advantages of the present invention will become better understood with reference to the following drawings, description, and claims.

### BRIEF DESCRIPTION OF THE DRAWINGS

FIGS. 1A and 1B depict a personalized wine charm according to the present invention;

FIG. 2 depicts a cross section of a personalized wine charm according to the present invention; and

FIG. 3 depicts a flowchart of a method according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

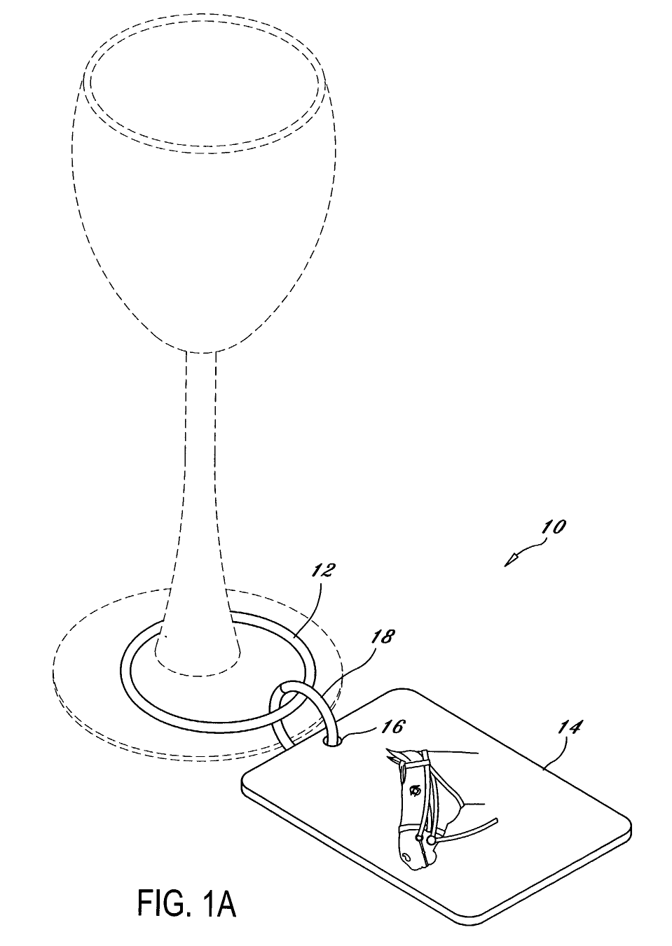

The present invention may be utilizes to identify the owner of drinkware. Also, the present invention may be used as gifts, give aways and advertisements at a restaurant or bar. There has been a need within the art for such devices and method of manufacture that provide sturdy and easy to manufacture personalized wine disks. Also, there has been a need for wine disks that provide images or photos, rather than merely jewelry and three dimensional figures. According to one embodiment depicted in FIG. 1A, a device 10 for identifying drinkware having a structural portion is disclosed. The term drinkware may be used to describe coffee cups, tea cups, wine glasses, and any other drinkware known within the art. The device has a first ring type member 12 to be attached to a structural portion of drinkware and an image disk 14 with a hole 16 for the receipt of a second ring type member 18. The first ring type member 12 may have an outer diameter between 0.50 and 1.50 inches when closed. According to the preferred embodiment, ring type members may be in an opened position and a closed position. That is, the ring is not continuous, but rather has a cut which facilitates bending to open and bending to close around the image disk or stem of the drinkware. The second ring type member 18 passes through the first ring type member 12 so as to allow the image disk 14 to lay flat. The second ring type member 18 may have an outer diameter between 0.125 and 0.25 inches.

FIG. 1B depicts a device 10 for identifying drinkware with a first ring type member 17 and an image disk 15. The first ring type member may be directly attached to the stem of drinkware. The first ring type member may preferably have an outer diameter between 0.50 and 1.50 inches, and an inner diameter between 0.46 and 1.45 inches.

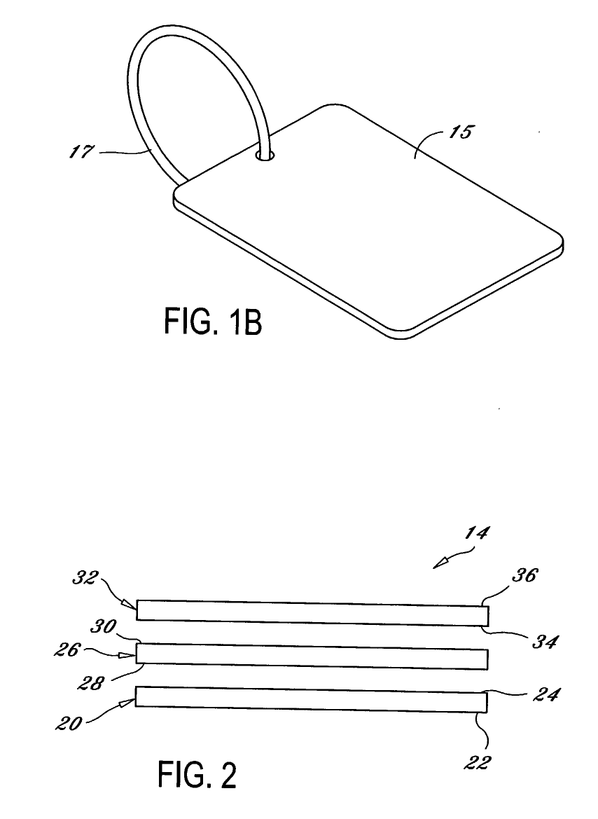

FIG. 2 depicts a cross section of the image disk according to one embodiment. As shown, the image disk may be comprised of a first metal layer 20 with a bottom portion 22 and a top portion 24; a first plastic layer 26 with a bottom portion 28 and a top portion 30, wherein the bottom portion 28 of the first plastic layer 28 may be in combination with the top portion 24 of the first metal layer 20; a second plastic layer 32 with a bottom portion 34 and a top portion 36, wherein the bottom portion 34 of the second plastic layer 32 is in communication with the top portion 30 of the first plastic layer 26 and the top portion 36 of the second plastic layer 32 protects the image embedded therein.

An image may be embedded in the first plastic layer 26 by bonding and/or crosslinking of colorants by the reaction between compounds selected from each of two chemical groups as disclosed by patent application US 2002/0135648 applied for by Thomson et al and incorporated herein by reference. The first group comprises compounds with functional groups capable of reacting with active hydrogen. The second group comprises compounds with functional groups containing active hydrogen, or compounds with functional groups containing active hydrogen after a conversion process. Either the first group or the second group may be present in the ink, and an image is printed onto transfer paper. According to one embodiment, the first plastic layer 26 comprises either the first or second group as appropriate and reacts with the ink. The image may be permanently fixed under the second plastic layer 32, by the presence of protecting or blocking agents, which are removed by the application of heat or other energy. Upon reaction, the colorant is bonded to the first plastic layer 26, and the second plastic layer 32 provides a protective coating over the image. In this way, the image may be bonded and/or crosslinked to the first metal layer 20, and the second plastic layer 32 protects the image.

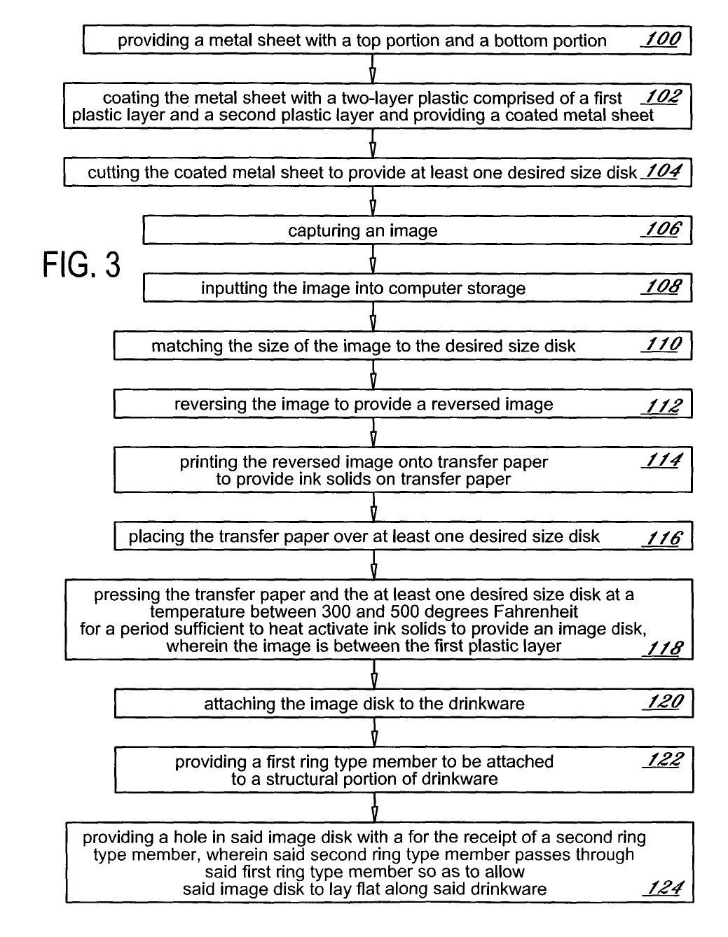

According to a preferred embodiment, as depicted in FIG. 3, a method of manufacturing an image disk for identifying and advertising on drinkware is disclosed. This method may comprise the steps of: step 100 providing a sheet with a top portion and a bottom portion. The sheet may be made of aluminum, copper, tin, alloys, plastics, or any other suitable material. According to a preferred embodiment, the sheet is made of aluminum. Step 102 coating the sheet with a two-layer plastic comprised of a first plastic layer and a second plastic layer and providing a coated sheet. According to a preferred embodiment, the two-layer plastic may be Unisub sheet stock for Aluminum, Part No. UN5570, Aluminum Gloss. According to a preferred embodiment, the step of coating the sheet with a two layer plastic to provide a coated sheet, the two layer plastic may be comprised of a first plastic layer with a top portion and a bottom portion and a second plastic layer with a top portion and a bottom portion. The bottom portion of the first plastic layer being in communication with the top portion of the sheet, and the bottom portion of the second plastic layer being in communication with the top portion of the first plastic layer.

Step 104 is comprised of cutting the coated sheet to provide at least one desired size disk. Ideally, the disk should be of lightweight, and of a size such that it sits on the base of the wine glass.

Step 106 is capturing an image. The image may be captured in a number of ways including a video camera, scanning device, camera, and digital camera. Any means of forming the image may be used, including images generated by software. Available computer design graphic software may be used, or still photography may be used. The design may be photographic, graphic, artistic or simply letters of words.

Step 108 inputting the image into computer storage. This may be accomplished by uploading the document, scanning and saving the document, having an image emailed, downloaded or any other method of obtaining a digital image known within the art.

Step 110 matching the size of the image to the desired size disk. This step may be accomplished in a number of ways including using Photoshop, Corel or any other imaging software. Step 112 reversing the image to provide a reversed image. This may also be accomplished using any image software known within the art. Step 114 printing the reversed image onto transfer paper to provide ink solids on transfer paper. The step of printing the image onto transfer paper according to a preferred embodiment utilizes finely divided heat activated ink solids that are placed in an emulsion by means of an emulsifying enforcing agent that is present in a solvent. The process of printing is disclosed by US 2002/0050221 applied for by Xu et al and incorporated herein by reference. Step 116 placing the transfer paper over at least one desired size disk. The transfer paper may contain a number of images, and be placed over a number of disks. Step 118 pressing the transfer paper and at least one desired size disk at a temperature between 300 and 500 degrees Fahrenheit for a period sufficient to heat activate the ink solids to provide an image disk, wherein the image is between the first plastic layer and the second plastic layer. Ideally, the temperature is around 375 degrees. The period sufficient to heat activate the solids may be between thirty seconds and five minutes, preferably three minutes.

Step 120 attaching the image disk to the drinkware. This may be accomplished using a single ring type member, or a number of ring type members. According to a preferred embodiment, the step 120 of attaching the image disk to the drinkware may be accomplished by providing a first ring type member to be attached to a structural portion of drinkware and providing a hole in the image disk for the receipt of a second ring type member. The second ring type member passes through the first ring type member so as to allow the image disk to lay flat along the drinkware.

It should be understood, of course, that the foregoing relates to preferred embodiments of the invention and that modifications may be made without departing from the spirit and scope of the invention as set forth in the following claims.

I claim:

1. A device for identifying drinkware having a structural portion, said device comprising:
a first ring type member to be attached to a structural portion of drinkware; and
an image disk with a hole for the receipt of a second ring type member, wherein said second ring type member passes through said first ring type member so as to allow said image disk to lay flat.

2. A device as in claim 1, wherein said image disk is comprised of:
a first metal layer with a bottom portion and a top portion;
a first plastic layer with a bottom portion and a top portion, wherein said bottom portion of said first plastic layer is in combination with said top portion of said first metal layer; and
a second plastic layer with a, bottom portion and a top portion, wherein said bottom portion of said second plastic layer is in communication with said top portion of said first plastic layer and said top portion of said second plastic layer protects the image embedded therein.

3. A device as in claim 1, wherein said first ring type member has an outer diameter between 0.50 and 1.50 inches.

4. A device as in claim 1, wherein said second ring type member has an outer diameter between 0.125 and 0.25 inches.

5. A device as in claim 1, wherein said image disk has an image embedded therein selected from the group consisting of digital color image, color photographs, lithograph, scanned image and Polaroid.

6. A device for identifying drinkware having a structural portion, said device comprising:
a first ring type member to be attached to a structural portion of drinkware; and
an image disk with a hole for the receipt of said first ring type member so as to allow said image disk to be attached to said structural portion of said drinkware.

7. A device as in claim 6, wherein said first ring type member has an outer diameter between 0.50 and 1.50 inches.

8. A device as in claim 6, wherein said image disk is comprised of:
a first metal layer with a bottom portion and a top portion;
a first plastic layer with a bottom portion and a top portion, wherein said bottom portion of said first plastic layer is in combination with said top portion of said first metal layer; and
a second plastic layer with a bottom portion and a top portion, wherein said bottom portion of said second plastic layer is in communication with said top portion of said first plastic layer and said top portion of said second plastic layer protects the image embedded therein.

9. A device as in claim 6, wherein said first ring type member has an inner diameter between 0.46 and 1.45 inches.

10. A device as in claim 6, wherein said image disk is selected from the group consisting of digital color image, color photographs, lithograph, polaroid.

11. A method of manufacturing an image disk for identifying and advertising on drinkware, comprising the steps of:
providing a sheet with a top portion and a bottom portion;
coating said sheet with a two-layer plastic comprised of a first plastic layer and a second plastic layer and providing a coated sheet;
cutting said coated sheet to provide at least one desired size disk;
capturing an image;
inputting the image into computer storage;
matching the size of said image to said desired size disk;
reversing said image to provide a reversed image;
printing said reversed image onto transfer paper to provide ink solids on said transfer paper;
placing said transfer paper over said at least one desired size disk;
pressing said transfer paper and said at least one desired size disk at a temperature between 300 and 500 degrees Fahrenheit for a period sufficient to heat activate said ink solids to provide an image disk, wherein said image is between said first plastic layer and said second plastic layer; and
attaching said image disk to said drinkware.

12. A method as in claim 11, wherein said period sufficient to heat activate said ink solids is between 30 seconds and five minutes, preferably three minutes.

13. A method as in claim 11, wherein said step of printing said reversed image onto transfer paper utilizes heat activated inks.

14. A method as in claim 11, wherein said step of attaching said image disk to said drinkware further comprises the following steps:
providing a first ring type member to be attached to a structural portion of drinkware; and
providing a hole in said image disk for the receipt of a second ring type member, wherein said second ring type member passes through said first ring type member so as to allow said image disk to lay flat along said drinkware.

15. A method of manufacturing an image disk for identifying and advertising on drinkware, comprising the steps of:
providing a sheet with a top portion and a bottom portion;
coating said sheet with a two layer plastic to provide a coated sheet, wherein said two layer plastic is comprised of a first plastic layer with a top portion and a bottom portion and a second plastic layer with a top portion and a bottom portion, said bottom portion of said first plastic layer being in communication with said top portion of said sheet, and said bottom portion of said second plastic layer being in communication with said top portion of said first plastic layer;
cutting said coated sheet to provide at least one desired size disk;
capturing an image;
inputting said image into computer storage;
matching the size of said image to said desired size disk;
reversing said image to provide a reversed image;
printing said reversed image onto transfer paper using heat-activated dyes to provide ink solids on said transfer paper;
placing said transfer paper over said at least one desired size disk;
pressing said transfer paper and said at least one desired size disk at a temperature between 300 and 500 degrees Fahrenheit for a period between thirty seconds and five minutes to heat activate said ink solids to provide an image disk, wherein said image is sublimated under said top portion of said second plastic layer; and
attaching said image disk to said drinkware.

16. A method as in claim 15, wherein said period sufficient to heat activate said ink solids is between 30 seconds and five minutes, preferably three minutes.

17. A method as in claim 15, wherein said step of attaching said image disk to said drinkware further comprises the following steps:
providing a first ring type member to be attached to a structural portion of drinkware; and
providing a hole in said image disk with a for the receipt of a second ring type member, wherein said second ring type member passes through said first ring type member so as to allow said image disk to lay flat along said drinkware.

18. A method of manufacturing an image disk for identifying and advertising on drinkware, comprising the steps of:
providing a sheet with a top portion and a bottom portion;
coating said sheet with a two layer plastic to provide a coated sheet, wherein said two layer plastic is comprised of a first plastic layer with a top portion and a bottom portion and a second plastic layer with a top portion and a bottom portion, said bottom portion of said first plastic layer being in communication with said top portion of said sheet, and said bottom portion of said second plastic layer being in communication with said top portion of said first plastic layer;
cutting said coated sheet to provide at least one desired size disk;
capturing an image;
inputting said image into computer storage;
matching the size of said image to said desired size disk;
reversing said image to provide a reversed image;
printing said reversed image onto transfer paper using heat-activated dyes containing a colorant and at least one compound having at least one functional group containing active hydrogen to provide ink solids on said transfer paper;
placing said transfer paper over said at least one desired size disk;
pressing said transfer paper and said at least one desired size disk at a temperature between 300 and 500 degrees Fahrenheit for a period between 30 seconds and five minutes to heat activate said ink solids to provide an image disk, wherein said image is sublimated under said top portion of said second plastic layer; and
attaching said image disk to said drinkware.
